(19) United States
(12) Patent Application Publication
(10) Pub. No.: US 2017/0155639 A1
(43) Pub. Date: Jun. 1, 2017

(54) SECURE UNIFIED CLOUD STORAGE

(71) Applicant: Alcatel Lucent, Boulogne Billancourt (FR)

(72) Inventors: Zhiyuan Hu, Shanghai (CN); Lin Wu, Shanghai (CN); Xueqiang Yan, Shanghai (CN); Zhigang Luo, Shanghai (CN)

(73) Assignee: Alcatel Lucent, Boulogne Billancourt (FR)

(21) Appl. No.: 15/316,761

(22) PCT Filed: Jun. 10, 2014
(86) PCT No.: PCT/CN2014/079628

§ 371 Date: Dec. 6, 2016

(51) Int. Cl. H04L 29/06; H04W 4/00; H04L 29/08; H04W 12/06

(52) U.S. Cl. CPC H04L 63/0815; H04W 12/06; H04W 4/001; H04L 67/306; H04L 67/1097

(57) ABSTRACT

A request is made by a client to be authenticated by a first cloud storage server that may be associated with a first service provider. An identity federation request is sent from the client to the first cloud storage server, wherein the identity federation request seeks to federate a user account of the client on the first cloud storage server with a user account of the client on a second cloud storage server that may be associated with a second service provider. The client is redirected from the first cloud storage server to the second cloud storage server. A request is made by the client to be authenticated by the second cloud storage server such that the second cloud storage server, once the client is authenticated, maps the user account on the first cloud storage server with the user account of the second cloud storage server and establishes identity federation there between.

### FIELD

The application relates generally to data storage systems, and more particularly to techniques for implementing secure unified cloud storage.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

The term “cloud” typically refers to a collective computing infrastructure that implements a cloud computing paradigm. For example, as per the National Institute of Standards and Technology (NIST Special Publication No. 800-145), cloud computing may be viewed as a model for enabling ubiquitous, convenient, on-demand network access to a shared pool of configurable computing resources (e.g., networks, servers, storage, applications, and services) that can be rapidly provisioned and released with minimal management effort or service provider interaction.

A cloud-based computing system can also typically implement “virtualization” functionality through use of a hypervisor. A hypervisor is a software program which executes on top of the physical computing system, and creates and manages virtual assets such as virtual machines and logical (storage) units. The hypervisor allocates hardware resources of the physical computing system to the virtual assets in a dynamic and transparent manner.

Thus, “cloud storage” is considered networked online storage where data is stored in virtualized pools of storage. For example, a service provider may operate a data center which includes such cloud storage, and a customer who desires his/her data to be hosted by the service provider may buy or lease storage capacity from the service provider. The service provider dynamically and transparently virtualizes the needed resources and exposes them as storage pools, which the customer then uses to store data. It is known that many service providers provide cloud storage services (also known as Storage-as-a-Service or SaaS) such as, but not limited to, enterprise-level cloud data storage services and consumer-level file hosting services. However, it has been realized that for each different cloud storage service provided by a service provider, there is typically a different SaaS application programming interface (API). This heterogeneity with respect to APIs results in a prohibitively large number of APIs needed to access these different cloud storage services.

To attempt to solve the above problem, the Open Mobile Alliance (OMA) has proposed a Unified Cloud Disk (UCD) approach as outlined, for example, in OMA Work Item Document entitled Unified Cloud Disk V1.0, W0273 and dated 2012-09-04. The UCD framework provides a unified cloud storage system in a mobile cloud computing environment for mobile operators (i.e., the mobile operators here are the service providers). In the UCD framework, mobile users or applications can use a standard SaaS application programming interface (API) to store data in federated (unified) cloud storage across multiple mobile operators.

### SUMMARY

Illustrative embodiments of the invention provide techniques and apparatus for secure unified cloud storage. While embodiments are applicable to varied types of data storage systems, one or more embodiments are particularly well-suited for use in a UCD framework.

For example, in one embodiment, a method includes the following steps. A request is made by a client to be authenticated by a first cloud storage server that may be associated with a first service provider. An identity federation request is sent from the client to the first cloud storage server, wherein the identity federation request seeks to federate a user account of the client on the first cloud storage server with a user account of the client on a second cloud storage server that may be associated with a second service provider. The client is redirected from the first cloud storage server to the second cloud storage server. A request is made by the client to be authenticated by the second cloud storage server such that the second cloud storage server, once the client is authenticated, maps the user account on the first cloud storage server with the user account of the second cloud storage server and establishes identity federation there between. The client is redirected from the second cloud storage server to the first cloud storage server, and may receive a confirmation of the identity federation. Other embodiments comprise a single sign-on method, a single logout method, and an identity defederation method.

In another embodiment, an article of manufacture is provided which comprises a processor-readable storage medium having encoded therein executable code of one or more software programs. The one or more software programs when executed by at least one processing device implement steps of the above-described method.

In yet another embodiment, an apparatus comprises a memory and a processor configured to perform steps of the above-described method.

In one UCD example, the client comprises a UCD client, the first cloud storage server comprises a slave UCD server, and the second cloud storage server comprises a master UCD server.

Advantageously, illustrative embodiments integrate security techniques in a UCD framework.

These and other features and advantages of the present invention will become more apparent from the accompanying drawings and the following detailed description.

### BRIEF DESCRIPTION OF THE DRAWINGS

FIG. 1 shows a unified data storage system environment in which one or more embodiments of the invention are implemented.

FIG. 2 shows an identity federation request methodology according to one embodiment of the invention.

FIG. 3 shows a single sign-on methodology according to one embodiment of the invention.

FIG. 4 shows a single logout methodology according to one embodiment of the invention.

FIG. 5 shows an identity defederation request methodology according to one embodiment of the invention.

FIG. 6 shows a processing platform on which unified data storage systems and methodologies according to one or more embodiments of the invention are implemented.

### DETAILED DESCRIPTION

Illustrative embodiments of the invention will be described herein with reference to exemplary computing systems, data storage systems, communication systems, processing platforms, networks, user devices, network nodes, network elements, clients, servers, and associated communication protocols. For example, illustrative embodiments are particularly well-suited for use in a Unified Cloud Disk (UCD) environment. However, it should be understood that embodiments of the invention are not limited to use with the particular arrangements described, but are instead more generally applicable to any environment in which it is desirable to provide improved performance by providing secure unified data storage functionality.

As used herein, the term “client” illustratively refers to software, hardware, or a combination thereof that is programmed and/or configured to perform a function or service for an end user (e.g., customer). The term “server” illustratively refers to software, hardware, or a combination thereof that is programmed and/or configured to perform a function or service for a service provider, typically in response to a request from an end user (e.g., customer). A processing device can be programmed and/or configured to operate as a client for one purpose and a server for another purpose, or to operate as a dedicated client or a dedicated server. In this context, reference will be made below to a “UCD client” and a “UCD server” (e.g., master and slave UCD servers, as will be further explained below), which are client and server elements that operate in a UCD environment.

As mentioned above, the cloud storage framework provided by UCD has been proposed to overcome the problem of a customer having to utilize many different APIs when the customer chooses to store data across different cloud storage services and providers. For example, consider a customer who wishes to store files across different cloud storage services maintained by different service providers. Prior to the UCD framework, the client device of the customer would use separate, disparate interfaces to access the servers of the different service providers. However, with the UCD framework, the customer has access to multiple different service providers via a standard interface.

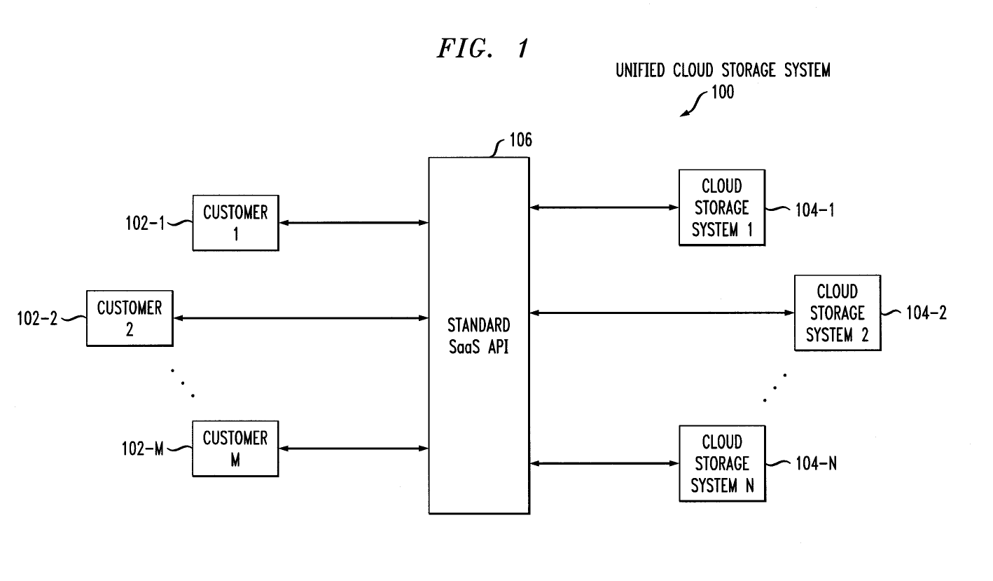

FIG. 1 shows a unified cloud storage system 100 (e.g., UCD system) wherein a customer (e.g., customer 102-1, 102-2, . . . , 102-M), via a client, is able to access a plurality of different cloud storage systems (104-1, 104-2, . . . , 104-N), each comprising one or more servers, via a standard SaaS API 106. For example, assume that the client (UCD client) of customer 102-1 initially registers with the servers (UCD servers) of each of the cloud storage systems 104-1, 104-2, . . . , 104-N via API 106. The client of customer 102-1 can then access (e.g., store and retrieve) data in each different cloud storage system via a single standard interface, i.e., standard SaaS API 106. This is referred to as “federated cloud storage” since the client is able to access data stored across a combination of different cloud storage systems via a common interface thus forming a unified cloud storage system.

However, as in any data storage scenario, security is a major consideration in the UCD framework. Thus, security techniques are desirable for authenticating the identity of UCD clients seeking to access federated cloud storage in a UCD framework.

One security technique is referred to as “identity federation.” In identity federation, a user is allowed to federate (e.g., link, connect, or bind) local “identities” (e.g., a user identifier, password, an email address, personal preferences, etc.) that have been created for each service provider. The linked local identities, referred to as a “federated identity,” allow the user to log in to one service provider website and click through to an affiliated service provider. Thus, identity federation occurs when a user chooses to unite distinct service provider accounts with one or more identity provider accounts. A user retains the individual account information with each provider while simultaneously establishing a link that allows the exchange of information between them. An example of an identity federation protocol is the Liberty Alliance Project which defines open-standard based specifications for identity federation, see, e.g., Cantor, Scott, Kemp, John, Champagne, Darryl, eds. “Liberty ID-FF Bindings and Profiles Specification,” Version 1.2-errata-v2.0, Liberty Alliance Project, 12 Sep. 2004 (referred to herein as “LibertyBindProf”); and Cantor, Scott, Kemp, John, eds. “Liberty ID-FF Protocols and Schema Specification,” Version 1.2-errata-v3.0, Liberty Alliance Project, 12 Sep. 2004 (referred to herein as “LibertyProtSchema”), the disclosures of which are incorporated by reference herein in their entireties.

However, it is realized herein that the Liberty Alliance Project specifications would impose a heavy overhead burden on the UCD framework. Accordingly, illustrative embodiments of the invention provide improved identity federation management methodologies for use in a unified cloud storage system such as the UCD framework.

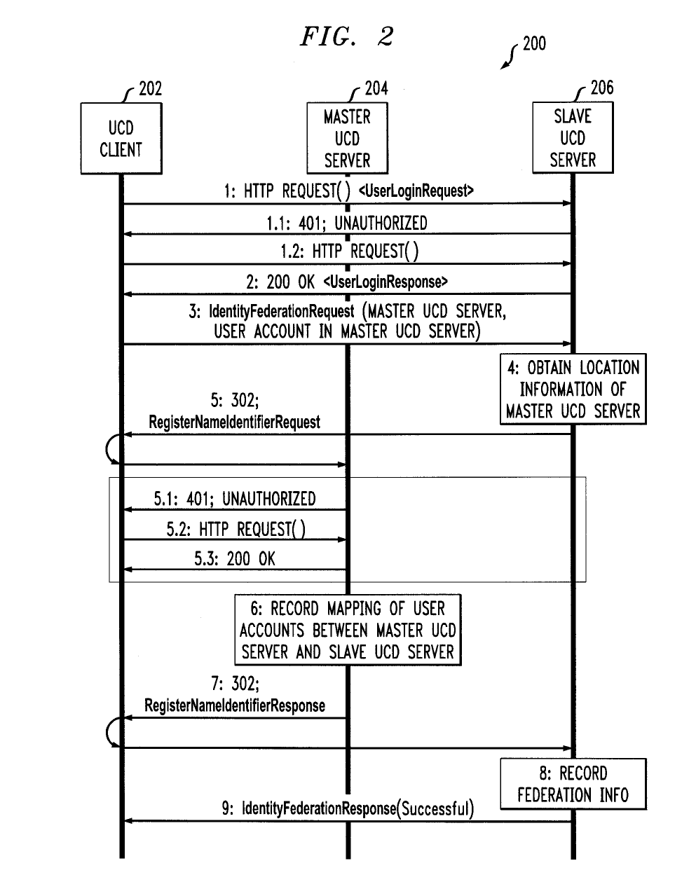

As will be described below in the context of FIGS. 2-5, illustrative embodiments of the invention provide identity federation methodologies that are implemented in a UCD environment that can utilize some adapted aspects of Liberty Alliance Project identity federation messages. However, it is to be appreciated that alternative embodiments of the invention can be implemented without such specific adapted Liberty Alliance Project messages in a straightforward manner given the inventive teachings provided herein.

Assume an end user (e.g., customer 102-1 in FIG. 1) wants to perform an identity federation procedure with a first cloud storage system (e.g., cloud storage system 104-1 in FIG. 1) associated with a first cloud storage service provider, i.e., in this case, with a Master UCD server. A Master UCD Server is a UCD server which has the functions of identity provider (as further explained below) and is chosen by the end user to register a Master UCD account. A methodology 200 for such identity federation, according to one embodiment, is shown in FIG. 2 with respect to a UCD client 202, a Master UCD Server 204, and a Slave UCD Server 206. A Slave UCD Server is a UCD server which may or may not have the functions of identity provider and is chosen by the end user to register a Slave UCD account. Note that the description of the procedure of an identity federation request initiated from the Master UCD Server 204 is omitted here to simplify the description, however, the procedure is evident and may be realized in a straightforward manner given the description given herein for FIG. 2.

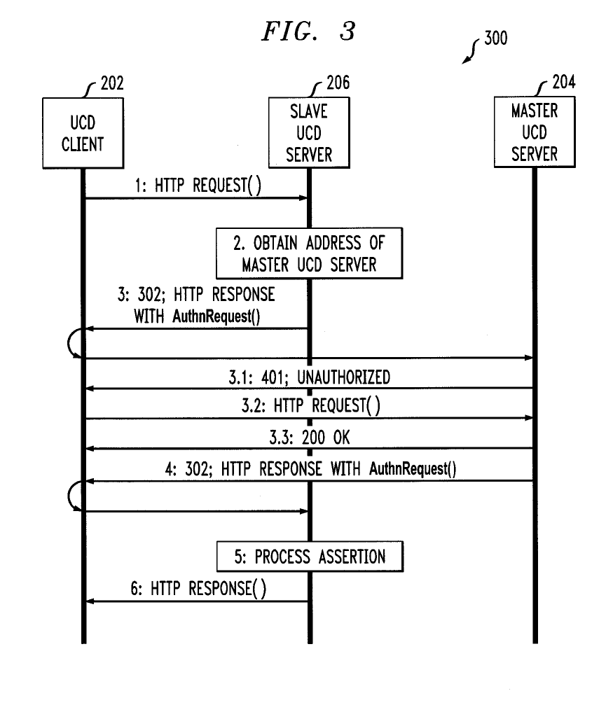

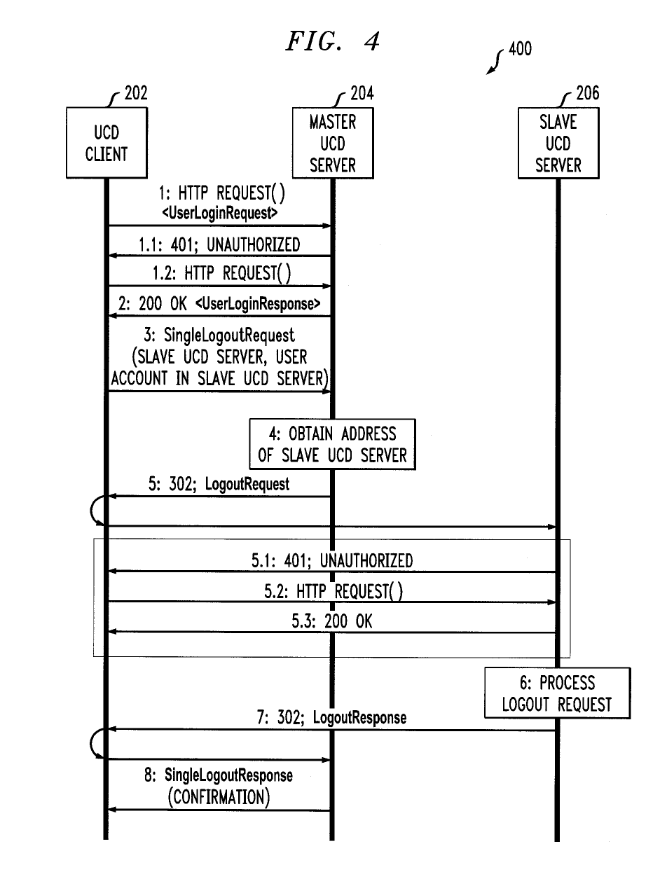

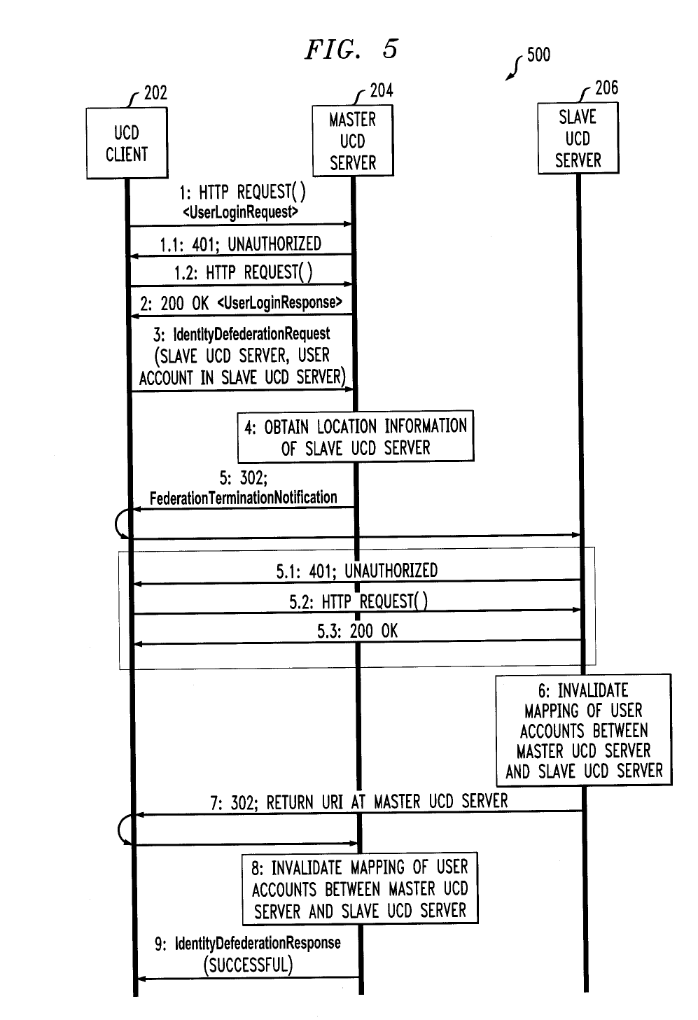

It is to be understood that, in one or more illustrative embodiments, an identity federation procedure as illustratively shown and described below in the context of FIG. 2 is a prerequisite for performing a single sign-on procedure as illustratively shown and described below in the context of FIG. 3, a single logout procedure as illustratively shown and described below in the context of FIG. 4, and an identity defederation procedure as illustratively shown and described below in the context of FIG. 5. That is, the end user has to federate his/her accounts in Slave UCD Servers with a Master UCD Server before he/she performs single sign-on, single logout, and/or identity defederation. However, separate embodiments of the invention are understood to comprise each separate methodology respectively depicted in FIGS. 2-5.

In this illustrative embodiment, some assumptions for performing identity federation are as follows: (i) the service providers of UCD servers which include IdP functions establish service agreements with other service providers providing UCD service (note that an Identity Provider (IdP), also known as Identity Assertion Provider, is responsible for issuing identification information for services providers looking to interact/service with a given system); and (ii) the end user has registered and decided which UCD Server that may or may not have IdP functions to be his/her Slave UCD Server.

Methodology 200 shows an identity federation procedure initiated from Slave UCD Server 204 which is described as follows (note that the reference numbering of steps used below, 1., 1.1, 1.2, 2., . . . , 9., corresponds to the numbering of steps of the methodology depicted in FIG. 2):

1. The end user requests to log in to Slave UCD Server 206. Thus, UCD Client 202 sends the message UserLoginRequest (HTTP Request) including a user identity (e.g., user account identifier in Slave UCD Server 206) to Slave UCD Server 206. If the end user is already authenticated by Slave UCD Server 206 and has maintained login status, then the methodology 200 proceeds directly to step 3. When the end user is not already so authenticated, the methodology proceeds as follows:

1.1 Slave UCD Server 206 requests to authenticate the user. The message may include a challenge or random value to be used for authenticating the user.

1.2 UCD Client 202 replies to Slave UCD Server 204. The message includes user authentication information, e.g., a digest of credentials.

2. Slave UCD Server 206 authenticates the user according to authentication information (e.g., user account identifier in Slave UCD Server, user digest of credentials).

Slave UCD Server 206 replies to UCD Client 202 with the message UserLoginResponse including an indication of a successful response and a list of UCD Servers (at least including one UCD Server) which have IdP functions. Note that if the end user logs into his/her Master UCD Server, the list of servers will be the list of candidates for Slave UCD Servers. However, if the user logs into his/her Slave UCD Server, the list of servers will be the list of candidates for Master UCD Servers which support an IdP function.

3. The end user chooses one of the UCD Servers as her/his Master UCD Server (with which he/she already registered a master UCD account) with which to federate. UCD Client 202 sends the message IdentityFederationRequest to Slave UCD Server 206. This request message includes a user account identifier in Slave UCD Server, a user account identifier in Master UCD Server, and information about Master UCD Server (e.g., Master UCD Server address).

That is, the UCD Client 202 sends an identity federation request to Slave UCD Server 206 to federate the slave user account with the master user account. An example message format is as follows: IdentityFederationRequest (userIdM, userIdS, serverIdM, serverIdS), wherein userIdM is the user identifier in the Master UCD Server 204, userIdS is the user identifier in the Slave UCD Server 206, serverIdM is the uniform resource identifier (URI) of the Master UCD Server 204 when requesting federation to Slave UCD Server 206, and serverIdS is the URI of the Slave UCD Server 206 when requesting federation to Master UCD Server 204.

4. Slave UCD Server 206 obtains location information of Master UCD Server 204.

5. Slave UCD Server 206 redirects UCD Client 202 to Master UCD Server 204 using the message RegisterNameIdentifierRequest (HTTP message with status code 302). The message RegisterNameIdentifierRequest includes the address of Master UCD Server 204, the address of Slave UCD Server 206, the user account identifier in Master UCD Server 204, the user account identifier in Slave UCD Server 206, and a Slave UCD Server Certificate.

More particularly, one example format of this request message is RegisterNameIdentifierRequest (IDPProvidedNameIdentifier, SPProvidedNameIdentifier, ProviderID), wherein the IDPProvidedNameIdentifier field is the user identifier userIdM in the Master UCD Server, the SPProvidedNameIdentifier field is the user identifier userIdS in the slave UCD Server, and the ProviderID field is one of the following: (i) serverIdM: the URI of the Master UCD Server when requesting federation to Slave UCD Server; or (ii) serverIdS: the URI of the Slave UCD Server when requesting federation to Master UCD Server. This request message is digitally signed by Slave UCD Server 206. Slave UCD Server 206 validates the digital signature of Master UCD Server 204.

Before recording federation information (e.g., the mapping of user accounts between Master UCD Server and Slave UCD Server), Master UCD Server 204 authenticates the user to guarantee that this user has the right to federate the user account in Master UCD Server 204 with the user account in Slave UCD Server 206. There are several authentication mechanisms that may be employed. One illustrative, but non-limiting, authentication mechanism is as follows:

5.1 Master UCD Server 204 responds to UCD Client 202 to authenticate the user. The message may include a challenge or random value to be used for authenticating the user.

5.2 UCD Client 202 replies to Master UCD Server 204. The message includes user authentication information e.g., a digest of user credentials.

5.3 Master UCD Server 204 authenticates the user. Master UCD Server 204 replies to UCD Client 202 with the HTTP message 200 OK.

6. Master UCD Server 204 records federation information (i.e., mapping of user accounts between Master UCD Server 204 and Slave UCD Server 206).

7. Master UCD Server 204 redirects UCD Client 202 to Slave UCD Server 206 using the message RegisterNameIdentifierResponse (HTTP message with status code 302). The message RegisterNameIdentifierResponse includes a single sign-on token (SSOToken), Master UCD Server identity, user account identifier in Slave UCD Server, user account identifier in Master UCD Server, and Master UCD Server Certificate. This message is digitally signed by Master UCD Server 204.

One example format for the RegisterNameIdentifierResponse message is as follows: RegisterNameIdentifierResponse (ProviderID, Status, Assertion). The ProviderID field can be one of following: (i) serverIdM: the URI of the Master UCD Server when responding with a logout request from Master UCD Server to Slave UCD Server; or (ii) serverIdS: the URI of the Slave UCD Server when responding to a logout request from Slave UCD Server to Master UCD Server. The Status field contains the results of the requested processing. If identity federation is successfully performed, authentication assertions including SSOToken are generated and included in the Assertion field. Slave UCD Server 206 validates the digital signature of Master UCD Server 204.

8. Slave UCD Server 206 records federation information, i.e., the mapping of user accounts between Master UCD Server 204 and Slave UCD Server 206.

9. Slave UCD Server 206 responds to UCD Client 202 with the message IdentityFederationResponse, which may have the following example format: IdentityFederationResponse (Result, SSOToken), wherein the Result field is the result of the request processing, and if the identity federation is successfully performed, SSOToken is generated and provided to UCD Client 202 in the SSOToken field.

In this illustrative embodiment, the HyperText Transfer Protocol (HTTP) messaging between clients and servers is preferably implemented with Transport Layer Security (TLS) to maintain confidentiality and message integrity. The TLS 1.2 protocol is described in Internet Engineering Task Force (IETF) Request for Comment standard 5246, the disclosure of which is incorporated by reference herein in its entirety. However, message protocols and security protocols, other than HTTP and TLS, may be employed in alternative embodiments.

FIG. 3 shows a single sign-on (SSO) methodology 300 according to an illustrative embodiment (note that the reference numbering of steps used below, 1., 2., . . . , 6., corresponds to the numbering of steps of the methodology depicted in FIG. 3):

1. UCD Client 202 sends SSOLogin Request (HTTP Request) to Slave UCD Server 206 to access services. This message includes a user identifier in Slave UCD Server 206. This message may also include a valid SSOToken. For example, the message may have the following example format: SSOLoginRequest (userIdS, SSOToken), wherein userIdS is the user identifier in the Slave UCD Server, and SSOToken field contains the SSO Token. If the SSO token is empty or invalid, the UCD Server redirects the UCD Client to obtain a valid SSO token before allowing to access cloud storage services.

2. Slave UCD Server 206 obtains the address of the Master UCD Server 204 and checks if this request includes a valid authentication assertion (including SSOToken) generated by Master UCD Server 204. If yes, then the methodology proceeds directly to step 6.

3. If no valid authentication assertion is found in step 2, Slave UCD Server 206 redirects UCD Client 202 to Master UCD Server 204 with the message HTTP Response with AuthnRequest (HTTP message with status code 302). Note that AuthRequest may have the example format: AuthnRequest (NameIdentifier, ProviderID). The ProviderID field is the URI of Master UCD Server 204 and a NameIdentifier field includes the user identifier in Slave UCD Server 206.

Before issuing the authentication assertion, Master UCD Server 204 authenticates the end user as follows:

3.1 Master UCD Server 204 responds to UCD Client 202 to authenticate the user (HTTP message with status code 401). The message may include a challenge or random value to be used for authenticating the user.

3.2 UCD Client 202 replies to Master UCD Server 204. The message includes user authentication information, e.g., a digest of user credentials.

3.3 Master UCD Server 204 authenticates the user. Master UCD Server 204 replies to UCD Client 202 with the HTTP message 200 OK.

4. Master UCD Server 204 generates an authentication assertion (including SSOToken) for the user, and Master UCD Server 204 redirects UCD Client 202 to Slave UCD Server 206 with the message HTTP Response with AuthnReponse (including authentication assertion). Note that AuthResponse may have the following example format: AuthnResponse (ProviderID, Assertion). The ProviderID field is the URI of Master UCD Server 204 and an Assertion field is added which includes the result of the requested processing and authentication assertions including SSOToken which is generated after successful authentication.

5. Slave UCD Server validates the authentication assertion, by way of example only, using the validation described in the above-mentioned LibertyBindProf and LibertyProtSchema. Other ways to validate the authentication assertion may be employed.

6. Slave UCD Server 206 responds to UCD Client 202 with the message SSOLogin Response that either allows or denies access to the originally requested resource (e.g., cloud storage). An example format of this message is: SSOLoginResponse (Result, SSOToken) wherein the Result field is the result of the request processing, and the SSOToken field is optional when Slave UCD Server 206 gets a valid SSOToken from Master UCD Server 204. UCD Client 202 should extract SSOToken and store SSOToken.

In this illustrative embodiment as well, the HTTP messaging between clients and servers is preferably implemented with Transport Layer Security (TLS) to maintain confidentiality and message integrity.

FIG. 4 shows a single logout methodology 400 initiated at Master UCD Server 204 according to an illustrative embodiment (note that the reference numbering of steps used below, 1., 1.1, 1.2., . . . , 8., corresponds to the numbering of steps of the methodology depicted in FIG. 4). Note also that the description of the procedure of single logout initiated at Slave UCD Server 206 is omitted here to simplify the description, however, the procedure is evident and may be realized in a straightforward manner given the description given herein for FIG. 4.

Methodology 400 proceeds as follows:

1. User requests to log in to Master UCD Server 204. UCD Client 202 sends the message UserLoginRequest including user identity (e.g., user account identifier in Master UCD Server 204), e.g., example format UserLoginRequest (UserId). If user is already authenticated by Master UCD Server 204 and maintains login status, then methodology proceeds to step 3. If not:

1.1 Master UCD Server 204 responds to UCD Client 202 to authenticate the user. The message may include a challenge or random value to be used for authenticating the user.

1.2 UCD Client 202 sends the request to Master UCD Server 204. The message includes user authentication information, e.g., a digest of user credentials.

2. Master UCD Server 204 authenticates the user according to authentication information (e.g., user account identifier in Master UCD Server 204, user digest of credentials), and Master UCD Server 204 replies to UCD 202 Client with the message UserLoginResponse, as described above in FIG. 2.

3. UCD Client 202 sends message SingleLogoutRequest to Master UCD Server 204. This request message includes a user account identifier in Master UCD Server 204, a user account identifier in Slave UCD Server 206, and information about Slave UCD Server 206 (e.g., Slave UCD Server address). An example message format for the SingleLogoutRequest is as follows: SingleLogoutReqest (UserId, ServerId), wherein the userId field is one of the following: (i) userIdM: the user identifier in the Master UCD Server when requesting Logout from Master UCD Server to Slave UCD Server; or (ii) userIdS: the user identifier in the Slave UCD Server when requesting logout from Slave UCD Server to Master UCD Server. The ServerId field is the address of the Master UCD Server (when SingleLogoutRequest initiated at the Slave UCD Server) or the address of the Slave UCD Server (when SingleLogoutRequest initiated at the Master UCD Server) associated with userIdM or userIdS.

4. Master UCD Server 204 discovers all Slave UCD Servers (e.g., obtains address(es)) which the end user has logged in with the SSOToken issued by this Master UCD Server 204.

5. Then, Master UCD Server 204 separately redirects the message LogoutRequest from UCD Client 202 to those Slave UCD Servers, in this example, Slave UCD Server 206. Redirection steps 5.1, 5.2 and 5.3 are similar to those described above in the context of FIG. 2. The message LogoutRequest is signed by Master UCD Server 204. The message includes the address of Slave UCD Server 206, the address of Master UCD Server 204, the user account identifier in Master UCD Server 204, the user account identifier in Slave UCD Server 206, and Master UCD Server Certificate. Note that the LogoutRequest message may have the following example format: LogoutRequest (NameIdentifier, ProviderID), wherein the NameIdentifier field is one of the following: (i) userIdM: the user identifier in the Master UCD Server when requesting Logout from Master UCD Server to Slave UCD Server; or (ii) userIdS: the user identifier in the slave UCD Server when requesting logout from Slave UCD Server to Master UCD Server. The ProviderID field is one of the following: (i) serverIdM: the URI of the Master UCD Server when requesting Logout from Master UCD Server to Slave UCD Server; or (ii) serverIdS: the URI of the Slave UCD Server when requesting logout from Slave UCD Server to Master UCD Server.

6. Slave UCD Server 206 processes the logout request. That is, Slave UCD Server 206 validates the Master UCD Server's digital signature. If the signature is that of the Master UCD Server 204 that provided the authentication for the principal's current session, Slave UCD Server 206 invalidates the user's session(s) referred to by the <NameIdentifier>element, and any SessionIndex elements supplied in the message. Slave UCD Server 206 applies the logout request message to any assertion that meets certain requirements e.g., (a) the SessionIndex of the assertion matches one specified in the logout request; and/or (b) the assertion would otherwise be valid, even if the assertion arrives after the logout request.

7. Slave UCD Server 206 redirects UCD Client 202 to Master UCD Server 204 with the message LogoutResponse. This message is digitally signed by the Slave UCD Server 206. The Logout Response message may have the following example format: LogoutResponse (ProviderID, Status), wherein the ProviderID field has one of following: (i) serverIdM: the URI of the Master UCD Server when responding to Logout from Master UCD Server to Slave UCD Server; or (ii) serverIdS: the URI of the Slave UCD Server when responding logout from Slave UCD Server to Master UCD Server. The Status field includes the result of the request processing.

8. After receiving the messages LogoutResponse from each Slave UCD Server 206 (described above in step 4), Master UCD Server 204 sends SingleLogoutResponse to UCD Client 202 and confirms that UCD Client 202 logged out from Slave UCD Server 206. An example message format is SingleLogoutResponse (Result) wherein the Result field is the result of the request processing.

In this illustrative embodiment as well, the HTTP messaging between clients and servers is preferably implemented with Transport Layer Security (TLS) to maintain confidentiality and message integrity.

Now assume that the user wants to perform an identity defederation with a Master UCD Server. FIG. 5 illustrates such an identity defederation methodology. Note that the description of the procedure of an identity defederation request initiated from the Slave UCD Server 206 is omitted here to simplify the description, however, the procedure is evident and may be realized in a straightforward manner given the description given herein for FIG. 5.

Methodology 500 shows an identity defederation procedure initiated from Master UCD Server 204 which is described as follows (note that the reference numbering of steps used below, 1., 1.1, 1.2, 2., . . . , 9., corresponds to the numbering of steps of the methodology depicted in FIG. 5):

1. User requests to log in to Master UCD Server 204. The UCD Client 202 sends the message UserLoginRequest (as described above) including user identity (e.g., user account identifier in Master UCD Server 204). If the user is already authenticated by Master UCD Server 204 and maintains login status, then the methodology proceeds directly to step 3. If not:

1.1 Master UCD Server 204 responds to UCD Client 202 to authenticate the user. The message may include a challenge or random value to be used for authenticating the user.

1.2 UCD Client 202 sends a request to Master UCD Server 204. The message includes user authentication information, e.g., a digest of user credentials.

2. Master UCD Server 204 authenticates the user according to authentication information (e.g., user account identifier in Master UCD Server, digest of user credentials), and replies to UCD Client 202 with the message UserLoginResponse (as described above), containing a list of Slave UCD Server addresses.

3. The user chooses a Slave UCD Server to be defederated, i.e., assume here that the defederation request relates to Slave UCD Sever 206. UCD Client 202 sends the message IdentityDefederationRequest to Master UCD Server 204. This request message includes the user account identifier in Master UCD Server, the user account identifier in Slave UCD Server, and information about the Slave UCD Server (e.g., Slave UCD Server address).

An example format for the defederation request message is as follows: IdentityDefederationRequest (userIdM, userIdS, serverIdM, serverIdS), wherein userIdM is the user identifier in the Master UCD Server, userIdS is the user identifier in the Slave UCD Server, serverIdM is the URI of the Master UCD Server when requesting defederation to the Slave UCD Server userIdS, and serverIdS is the URI of the Slave UCD Server when requesting federation to Master UCD Server.

4. Master UCD Server 204 obtains location information of Slave UCD Server 206.

5. Master UCD Server 204 redirects UCD Client 202 to Slave UCD Server 206. This is accomplished using the message FederationTerminationNotification which includes the address of Slave UCD Server, the address of Master UCD Server, the user account identifier in Master UCD Server, the user account identifier in Slave UCD Server, and the Master UCD Server Certificate. The message is digitally signed by Master UCD Server.

An example format of the federation termination notification message is as follows: FederationTerminationNotification (NameIdentifier, ProviderID), wherein the NameIdentifier field is one of the following: (i) userIdM: the user identifier in the Master UCD Server when requesting defederation from Master UCD Server to Slave UCD Server; or (ii) userIdS: the user identifier in the slave UCD Server when requesting defederation from Slave UCD Server to Master UCD Server. The ProviderID field is one of the following: (i) serverIdM: the URI of the Master UCD Server when requesting defederation from Master UCD Server to Slave UCD Server; or (ii) serverIdS: the URI of the Slave UCD Server when requesting defederation from Slave UCD Server to Master UCD Server.

Slave UCD Server 206 validates the digital signature of Master UCD Server 204.

Before invalidating the federated information (e.g., the mapping of user accounts between Master UCD Server and Slave UCD Server), Slave UCD Server 206 authenticates the user to guarantee that this user has the right to do such defederation. There are several authentication mechanisms that may be employed. One illustrative, but non-limiting, authentication mechanism is as follows:

5.1 Slave UCD Server 206 responds to UCD Client 202 to authenticate the user. The message may include a challenge or random value to be used for authenticating the user.

5.2 UCD Client 202 replies to Slave UCD Server 206. The message includes user authentication information e.g., a digest of user credentials.

5.3 Slave UCD Server 206 authenticates the user. Slave UCD Server 206 replies to UCD Client 202 with the HTTP message 200 OK.

6. Slave UCD Server 206 invalidates (and may remove/delete) the mapping of user accounts between Master UCD Server 204 and Slave UCD Server 206.

7. Slave UCD Server 206 redirects UCD Client 202 to Master UCD Server 204. The response message includes the URI at Master UCD Server 204.

8. Master UCD Server invalidates (and may remove/delete) the mapping of user accounts between Master UCD Server 204 and Slave UCD Server 206.

9. Master UCD Server 204 responds to UCD Client 202 with the message IdentityDefederationResponse. An example format of the message is IdentityDefederationResponse (Result) wherein the Result field is the result of the request processing.

In this illustrative embodiment as well, the HTTP messaging between clients and servers is preferably implemented with Transport Layer Security (TLS) to maintain confidentiality and message integrity.

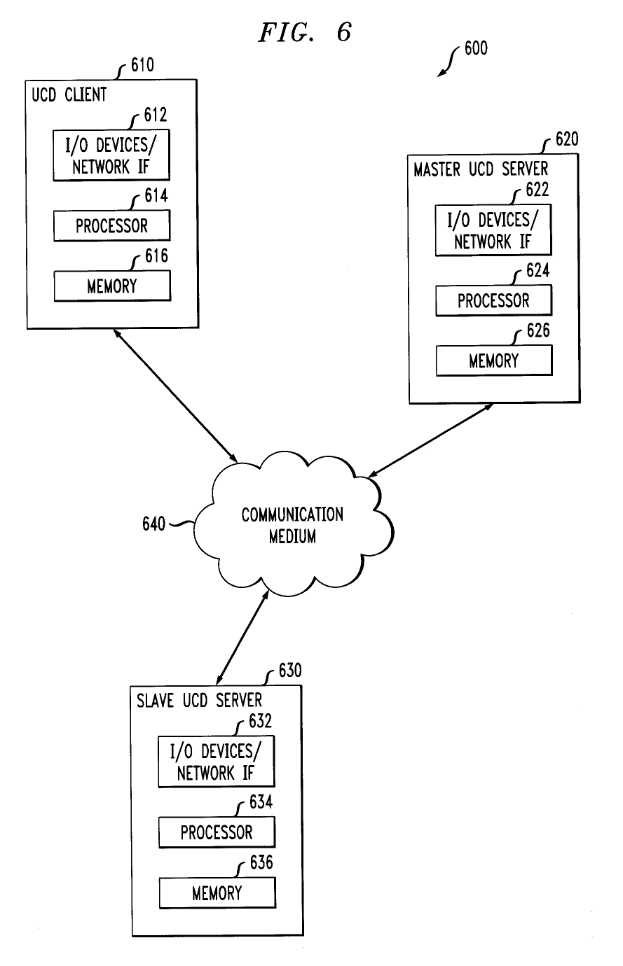

FIG. 6 shows a processing platform on which data storage systems and methodologies according to one or more embodiments of the invention are implemented. The processing platform 600 in this embodiment comprises a plurality of processing devices denoted 610, 620, and 630, which communicate with one another over a network 640. As illustrated, processing device 610 represents a UCD Client (e.g., UCD Client 202 in FIGS. 2-5), processing device 620 represents a Master UCD Server (e.g., Master UCD Server 204 in FIGS. 2-5), and processing device 630 represents a Slave UCD Server (e.g., Slave UCD Server 206 in FIGS. 2-5). Additional processing devices (not expressly shown) can be part of the processing platform 600. It is to be understood that one or more of the elements of the UCD framework (UCD Client and UCD Server) may each run on one or more computers or other processing platform elements, each of which may be viewed as an example of what is more generally referred to herein as a “processing device.” As illustrated in FIG. 6, such a device generally comprises at least one processor and an associated memory, and implements one or more functional modules for instantiating and/or controlling features of systems and methodologies described herein. Multiple elements or modules may be implemented by a single processing device in a given embodiment.

The processing device 610 in the processing platform 600 comprises a processor 614 coupled to a memory 616. The processor 614 may comprise a microprocessor, a microcontroller, an application-specific integrated circuit (ASIC), a field programmable gate array (FPGA) or other type of processing circuitry, as well as portions or combinations of such circuitry elements. Components of a system as disclosed herein can be implemented at least in part in the form of one or more software programs stored in memory and executed by a processor such as processor 614. Memory 616 (or other storage device) having such program code embodied therein is an example of what is more generally referred to herein as a non-transitory processor-readable (or computer-readable) storage medium. Articles of manufacture comprising such processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 616 may comprise electronic memory such as random access memory (RAM), read-only memory (ROM) or other types of memory, in any combination. The one or more software programs when executed by a processing device such as the processing device 610 causes the device to perform functions associated with one or more of the components/steps of system/methodologies 200, 300, 400 and/or 500. One skilled in the art would be readily able to implement such software given the teachings provided herein. Other examples of processor-readable storage media embodying embodiments of the invention may include, for example, optical or magnetic disks.

Also included in the processing device 610 is I/O devices/network interface circuitry 612. I/O devices include one or more input devices (e.g., keyboard, keypad, mouse, touchscreen, etc.) for inputting data to the processing device, as well as one or more output devices (e.g., computer display, screen, graphical user interface, etc.) for providing results associated with the processing device. The network interface includes circuitry which is used to interface the processing device with a network (e.g., 640) and other network components (e.g., 620 and 630). Such circuitry may include conventional transceivers of a type well known in the art.

The other processing devices 620 (with I/O devices/network interface 622, processor 624, and memory 626) and 630 (with I/O devices/network interface 632, processor 634, and memory 636) of the processing platform 600 are assumed to be configured in a manner similar to that shown for processing device 610 in the figure.

Although certain illustrative embodiments are described herein in the context of communication networks and systems utilizing particular communication protocols, other types of networks and systems can be used in other embodiments. As noted above, the term “network” or “system” as used herein is therefore intended to be broadly construed. Further, it should be emphasized that the embodiments described above are for purposes of illustration only, and should not be interpreted as limiting in any way. Other embodiments may use different types of network, system, device and module configurations, and alternative communication protocols, process steps and operations for implementing security functionality. The particular manner in which the user devices and network nodes communicate can be varied in other embodiments. Also, it should be understood that the particular assumptions made in the context of describing the illustrative embodiments should not be construed as requirements of the invention. The invention can be implemented in other embodiments in which these particular assumptions do not apply. These and numerous other alternative embodiments within the scope of the appended claims will be readily apparent to those skilled in the art.

1. A method comprising:
requesting, by a client, to be authenticated by a first cloud storage server;
sending, from the client, an identity federation request to the first cloud storage server, wherein the identity federation request seeks to federate a user account of the client on the first cloud storage server with a user account of the client on a second cloud storage server;
redirecting the client from the first cloud storage server to the second cloud storage server;
requesting, by the client, to be authenticated by the second cloud storage server such that the second cloud storage server, once the client is authenticated, maps the user account on the first cloud storage server with the user account of the second cloud storage server and establishes identity federation there between; and
redirecting the client from the second cloud storage server to the first cloud storage server;
wherein at least part of the method is one or more of the steps are performed by a processing device.

2. The method of claim 1, further comprising receiving, at the client from the second cloud storage server, a sign-on token for the client to sign on to a service of the first cloud storage server.

3. (canceled)

4. The method of claim 2, further comprising sending, from the client to the first cloud storage server, the sign-on token.

5.-10. (canceled)

11. The method of claim 1, further comprising:
sending, from the client, an identity defederation request to the second cloud storage server, wherein the identity defederation request seeks to defederate the user account of the client on the first cloud storage server with the user account of the client on the second cloud storage server;
redirecting the client from the second cloud storage server to the first cloud storage server;
requesting, by the client, to be authenticated by the first cloud storage server such that the first cloud storage server, once the client is authenticated, invalidates or deletes the mapping of the user account on the first cloud storage server with the user account of the second cloud storage server thereby ending the identity federation between the user accounts on the first and second cloud storage servers; and
redirecting the client from the first cloud storage server to the second cloud storage server.

12. (canceled)

13. An article of manufacture comprising a processor-readable storage medium having embodied therein executable program code that when executed by the processing device causes the processing device to perform the method of claim 1.

14. An apparatus comprising a memory and a processor operatively coupled to the memory and configured to perform the method of claim 1.

15. A method comprising:
receiving, at a first cloud storage server, a request from a client to be authenticated;
receiving, at the first cloud storage server from the client, an identity federation request, wherein the identity federation request seeks to federate a user account of the client on the first cloud storage server with a user account of the client on a second cloud storage server; and
redirecting the client from the first cloud storage server to the second cloud storage server such that the client requests to be authenticated by the second cloud storage server and such that the second cloud storage server, once the client is authenticated, maps the user account on the first cloud storage server with the user account of the second cloud storage server and establishes identity federation there between, and redirects the client from the second cloud storage server to the first cloud storage server;
wherein at least part of the method is one or more of the steps are performed by a processing device.

16. An article of manufacture comprising a processor-readable storage medium having embodied therein executable program code that when executed by the processing device causes the processing device to perform the method of claim 15.

17. An apparatus comprising a memory and a processor operatively coupled to the memory and configured to perform the method of claim 15.

18. A method comprising:
in response to an identity federation request from a client to a first cloud storage server, wherein the identity federation request seeks to federate a user account of the client on the first cloud storage server with a user account of the client on a second cloud storage server, receiving, at the second cloud storage server, a request from the client to be authenticated;
after the client is authenticated, mapping the user account on the first cloud storage server with the user account of the second cloud storage server and establishing identity federation there between; and
redirecting the client from the second cloud storage server to the first cloud storage server;
wherein at least part of the method is performed by a processing device.

19. An article of manufacture comprising a processor-readable storage medium having embodied therein executable program code that when executed by the processing device causes the processing device to perform the method of claim 18.

20. An apparatus comprising a memory and a processor operatively coupled to the memory and configured to perform the method of claim 18.

21. A method comprising:
configuring a client to request to be authenticated by a first cloud storage server;
configuring the client to send an identity federation request to the first cloud storage server, wherein the identity federation request seeks to federate a user account of the client on the first cloud storage server with a user account of the client on a second cloud storage server;
configuring the client to redirect from the first cloud storage server to the second cloud storage server;
configuring the client to request to be authenticated by the second cloud storage server such that the second cloud storage server, once the client is authenticated, maps the user account on the first cloud storage server with the user account of the second cloud storage server and establishes identity federation there between; and
configuring the client to redirect from the second cloud storage server to the first cloud storage server.

22. A method comprising:
configuring a first cloud storage server to receive a request from a client to be authenticated;
configuring the first cloud storage server to receive from the client an identity federation request, wherein the identity federation request seeks to federate a user account of the client on the first cloud storage server with a user account of the client on a second cloud storage server; and
configuring the first cloud storage server to redirect the client from the first cloud storage server to the second cloud storage server such that the client requests to be authenticated by the second cloud storage server and such that the second cloud storage server, once the client is authenticated, maps the user account on the first cloud storage server with the user account of the second cloud storage server and establishes identity federation there between, and redirects the client from the second cloud storage server to the first cloud storage server.

23. A method comprising:
configuring a first cloud storage server to receive from a client a request to be authenticated, in response to an identity federation request from the client to a second cloud storage server, wherein the identity federation request seeks to federate a user account of the client on the second cloud storage server with a user account of the client on the first cloud storage server;
configuring the first cloud storage server to map the user account on the second cloud storage server with the user account of the first cloud storage server and establish identity federation there between, after the client is authenticated; and
configuring the first cloud storage server to redirect the client to the second cloud storage server.
